(19) United States
(12) Patent Application Publication
(10) Pub. No.: US 2021/0357103 A1
(43) Pub. Date: Nov. 18, 2021

(54) INFORMATION PROCESSING DEVICE, DISPLAY SYSTEM, DISPLAY CONTROL METHOD, AND NON-TRANSITORY READABLE MEDIUM

(71) Applicant: TOYOTA JIDOSHA KABUSHIKI KAISHA, Toyota-shi (JP)

(72) Inventors: Shodai KATO, Nisshin-shi (JP); Toru Sakamoto, Anjo-shi (JP)

(73) Assignee: TOYOTA JIDOSHA KABUSHIKI KAISHA, Toyota-shi (JP)

(21) Appl. No.: 17/217,435

(22) Filed: Mar. 30, 2021

(30) Foreign Application Priority Data
May 13, 2020 (JP) 2020-084398

(51) Int. Cl. G06F 3/0481; G06F 3/0482; G01C 21/36

(52) U.S. Cl. CPC G06F 3/04817; G06F 3/0482; G01C 21/3617; G01C 21/3685; G01C 21/3682; G01C 21/3697

(57) ABSTRACT

An information processing device includes a processor. The processor is configured to: determine a select tendency of a user in selecting a facility, based on a history of the user's designations of the facility that belongs to a predetermined category; determine whether the positions of a plurality of facilities are concentrated on a map; and select, when the positions of the facilities are concentrated on the map, a Point-of-Interest icon to be displayed as a representative in accordance with the select tendency, from among Point-of-Interest icons for the facilities.

### CROSS-REFERENCE TO RELATED APPLICATION

This application claims priority to Japanese Patent Application No. 2020-084398 filed on May 13, 2020, incorporated herein by reference in its entirety.

### BACKGROUND

### 1. Technical Field

The present disclosure relates to an information processing device, a display system, a display control method, and a non-transitory readable medium, and particularly relates to display of a Point-of-Interest (POI) icon on a map.

### 2. Description of Related Art

There is known a technique of displaying a map on a display as performed by a navigation device that provides guidance for travel of a vehicle. When displaying a map, a POI icon is occasionally displayed on the map. The POI icon is an icon that represents a facility such as a parking lot, and is displayed at a position on the map at which the facility is present.

If all the POI icons for facilities are displayed when the facilities are concentrated, the POI icons are displayed in a concentrated manner, which lowers the viewability of the map. Japanese Unexamined Patent Application Publication No. 2002-340588 (JP 2002-340588 A) discloses a technique of improving the viewability of a map by displaying only one representative icon, rather than displaying all the POI icons, when the POI icons are concentrated on a map image.

### SUMMARY

In the technique according to the document described above, an icon with a predetermined mark (specifically, an icon with an “M” mark) is merely displayed as the representative icon. Therefore, convenience to a user is not taken into consideration when displaying the representative icon.

The present disclosure provides an information processing device, a display system, a display control method, and a non-transitory readable medium that display a map with a POI icon and that improves viewability while improving convenience to a user.

An information processing device according to a first aspect of the present disclosure includes a processor configured to determine a select tendency of a user in selecting a facility based on a history of the user's designations of the facility that belongs to a predetermined category. The processor is configured to determine whether positions of a plurality of facilities are concentrated on a map. The processor is configured to select, when the positions of the facilities are concentrated on the map, a Point-of-Interest icon to be displayed as a representative in accordance with the select tendency, from among Point-of-Interest icons for the facilities. With the information processing device according to the first aspect of the present disclosure, when the positions of the facilities are concentrated on the map, the Point-of-Interest icon for a facility that matches the select tendency of the user is displayed on the map as a representative icon. Therefore, an icon for a facility that the user prefers can be displayed as the representative icon. Thus, viewability can be improved while improving convenience to the user in displaying a map with a Point-of-Interest icon.

In the information processing device according to the first aspect described above, the processor may be configured to sort the facilities in accordance with the select tendency, and determine an order in which information on the facilities is displayed in a list. With the information processing device according to the first aspect of the present disclosure, a list sorted in accordance with the select tendency of the user can be displayed. Therefore, information on the facilities can be provided in the order of facilities that the user prefers.

In the information processing device according to the first aspect described above, the history of the user's destinations may be a history that the user designated the facilities as a destination. With the information processing device according to the first aspect of the present disclosure, the select tendency of the user is determined based on whether the facility is designated as a destination. Therefore, display that reflects the preference of the user for the destination can be made.

In the information processing device according to the first aspect described above, the processor may be configured to determine the select tendency of the user based on the history of the user's designations of the facilities associated with a plurality of types of information. The select tendency may depend on at least one of the types of information. With the information processing device according to the first aspect of the present disclosure, a representative icon is determined in accordance with information on which the user places an importance. Therefore, display that reflects the preference of the user for the information on which the user places an importance can be made.

In the information processing device according to the first aspect described above, the types of information may include a distance from a present location of the user to the facility or a distance from a destination that is different from the facility to the facility. With the information processing device according to the first aspect of the present disclosure, display that reflects the preference of the user for the distance can be made.

In the information processing device according to the first aspect described above, the types of information may include an index value of evaluation of the facility. With the information processing device according to the first aspect of the present disclosure, display that reflects the preference of the user for the evaluation of the facility can be made.

In the information processing device according to the first aspect described above, the facility may be a parking lot, and the types of information may include a parking fee of the parking lot. With the information processing device according to the first aspect of the present disclosure, display that reflects the preference of the user for the parking fee can be made.

In the information processing device according to the first aspect described above, the facility may be a parking lot, and the types of information may include a status of vacancy of parking spaces in the parking lot. With the information processing device according to the first aspect of the present disclosure, display that reflects the preference of the user for the status of vacancy of parking spaces can be made.

In the information processing device according to the first aspect described above, the facility may be a parking lot, and the types of information may include an index value of ease of parking of a vehicle in the parking lot. With the information processing device according to the first aspect of the present disclosure, display that reflects the preference of the user for the ease of parking of a vehicle can be made.

A display system according to a second aspect of the present disclosure includes a terminal device that has a display and an information processing device. The information processing device is configured to determine a select tendency of a user in selecting a facility based on a history of the user's designations of the facility that belongs to a predetermined category, determine whether positions of a plurality of facilities are concentrated on a map, and select, when the positions of the facilities are concentrated on the map, a Point-of-Interest icon to be displayed as a representative, from among Point-of-Interest icons for the facilities, in accordance with the select tendency. The terminal device is configured to control display on the display so as to display, on the display, the Point-of-Interest icon for the facility selected by the information processing device on the map as a representative of the Point-of-Interest icons for the facilities. With the display system according to the second aspect of the present disclosure, when the positions of the facilities are concentrated on the map, the Point-of-Interest icon for a facility that matches the select tendency of the user is displayed on the map as a representative icon. Therefore, an icon for a facility that the user prefers can be displayed as the representative icon. Thus, viewability can be improved while improving convenience to the user in displaying a map with a Point-of-Interest icon.

In the display system according to the second aspect described above, the terminal device may be configured to control display on the display so as to display a number of facilities determined as concentrated together with the Point-of-Interest icon for the facility selected in accordance with the select tendency. With the display system according to the second aspect of the present disclosure, the total number of concentrated facilities is displayed. Therefore, convenience to the user can be further improved.

In the display system according to the second aspect described above, the terminal device may be configured to control display on the display so as to display the Point-of-Interest icon for the facility selected in accordance with the select tendency at a position of the facility on the map. With the display system according to the second aspect of the present disclosure, the Point-of-Interest icon for the facility that the user prefers is displayed at the position of the facility. Therefore, the position of the facility that the user prefers can be displayed in an easily seeable manner.

In the display system according to the second aspect described above, the terminal device may be configured to receive an input to designate the facility that belongs to the predetermined category as a destination from the user, and notify the information processing device of the destination designated by the input. The information processing device may be configured to determine the select tendency of the user in selecting the facility based on the history of the user's designations of the facility that belongs to the predetermined category. The facility may be designated as the destination. The history of the user's designations may be communicated from the terminal device. With the display system according to the second aspect of the present disclosure, it is possible to easily acquire information for determining the select tendency, and display that reflects the preference of the user for the destination can be made.

A display control method according to a third aspect of the present disclosure includes: determining a select tendency of a user in selecting a facility based on a history of the user's designations of the facility that belongs to a predetermined category; determining whether positions of a plurality of facilities are concentrated on a map; and selecting, when the positions of the facilities are concentrated on the map, a Point-of-Interest icon to be displayed as a representative in accordance with the select tendency, from among Point-of-Interest icons for the facilities. With the display control method according to the third aspect of the present disclosure, when the positions of the facilities are concentrated on the map, the POI icon for a facility that matches the select tendency of the user is displayed on the map as a representative icon. Therefore, an icon for a facility that the user prefers can be displayed as the representative icon. Thus, viewability can be improved while improving convenience to the user in displaying a map with a POI icon.

A non-transitory readable medium according to a fourth aspect of the present disclosure stores instructions that are executable by one or more processors and that cause the one or more processors to perform functions. The functions include: determining a select tendency of a user in selecting a facility based on a history of the user's designations of the facility that belongs to a predetermined category; determining whether positions of a plurality of facilities are concentrated on a map; and selecting, when the positions of the facilities are concentrated on the map, a Point-of-Interest icon to be displayed as a representative in accordance with the select tendency, from among Point-of-Interest icons for the facilities. With the non-transitory readable medium according to the fourth aspect of the present disclosure, when the positions of the facilities are concentrated on the map, the POI icon for a facility that matches the select tendency of the user is displayed on the map as a representative icon. Therefore, an icon for a facility that the user prefers can be displayed as the representative icon. Thus, viewability can be improved while improving convenience to the user in displaying a map with a POI icon.

With the present disclosure, it is possible to provide an information processing device, a display system, a display control method, and a non-transitory readable medium that display a map with a POI icon and that improves viewability while improving convenience to a user.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram illustrating an example of the system configuration of a display system according to an embodiment;

FIG. 2 is a block diagram illustrating an example of the hardware configuration of an information processing device according to the embodiment;

FIG. 3 is a block diagram illustrating an example of the functional configuration of the information processing device according to the embodiment;

FIG. 4 is a block diagram illustrating an example of the hardware configuration of a terminal device according to the embodiment;

FIG. 5 is a block diagram illustrating an example of the functional configuration of the terminal device according to the embodiment;

FIG. 6 is a flowchart illustrating an example of a POI icon display process performed by the display system according to the embodiment;

FIG. 7 illustrates an example of display by the display system according to the embodiment;

FIG. 8 illustrates an example of display by the display system according to the embodiment; and

FIG. 9 illustrates an example of display by the display system according to the embodiment.

### DETAILED DESCRIPTION OF EMBODIMENTS

Embodiments of the present disclosure will be described below with reference to the drawings. In order to clarify description, the following description and the drawings are omitted and simplified as appropriate. In the drawings, in addition, identical elements are given identical signs to omit redundant description as necessary.

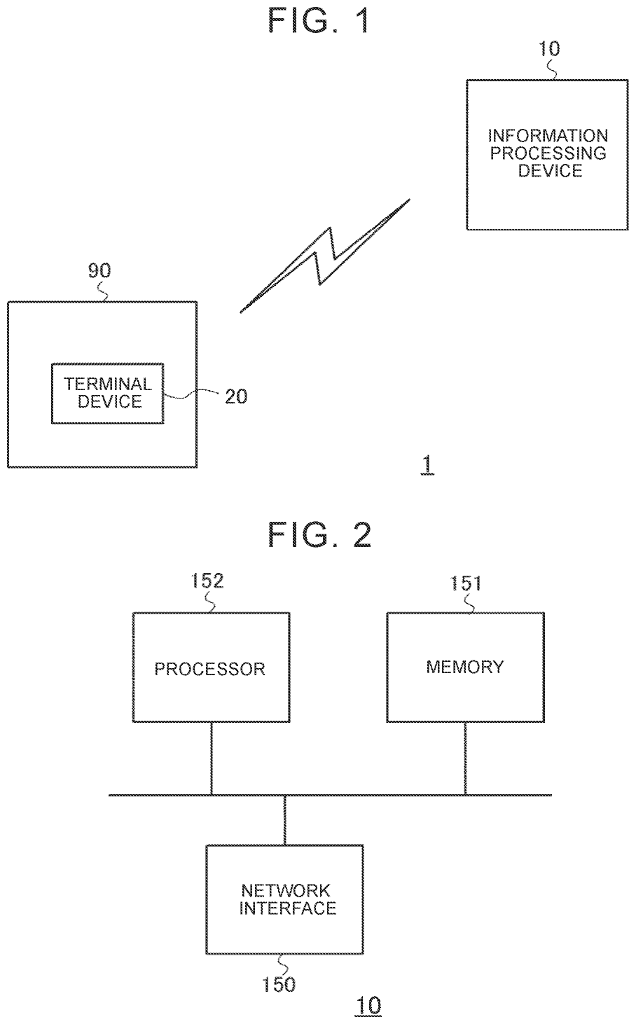

FIG. 1 is a schematic diagram illustrating an example of the system configuration of a display system 1 according to an embodiment. The display system 1 has an information processing device 10 and a terminal device 20.

In the present embodiment, by way of example, the terminal device 20 is mounted on a vehicle 90. However, the terminal device 20 may not necessarily be mounted on a vehicle. For example, the terminal device 20 may be a portable terminal such as a smartphone or a tablet terminal. The information processing device 10 is a device that functions as a server. The information processing device 10 and the terminal device 20 are communicably connected to each other via a communication network such as a cellular phone network.

First, the information processing device 10 will be specifically described. FIG. 2 is a block diagram illustrating an example of the hardware configuration of the information processing device 10. As illustrated in FIG. 2, the information processing device 10 includes a network interface 150, a memory 151, and a processor 152.

The network interface 150 is used to communicate with any different device. In the present embodiment, the network interface 150 is used to communicate with the terminal device 20, for example.

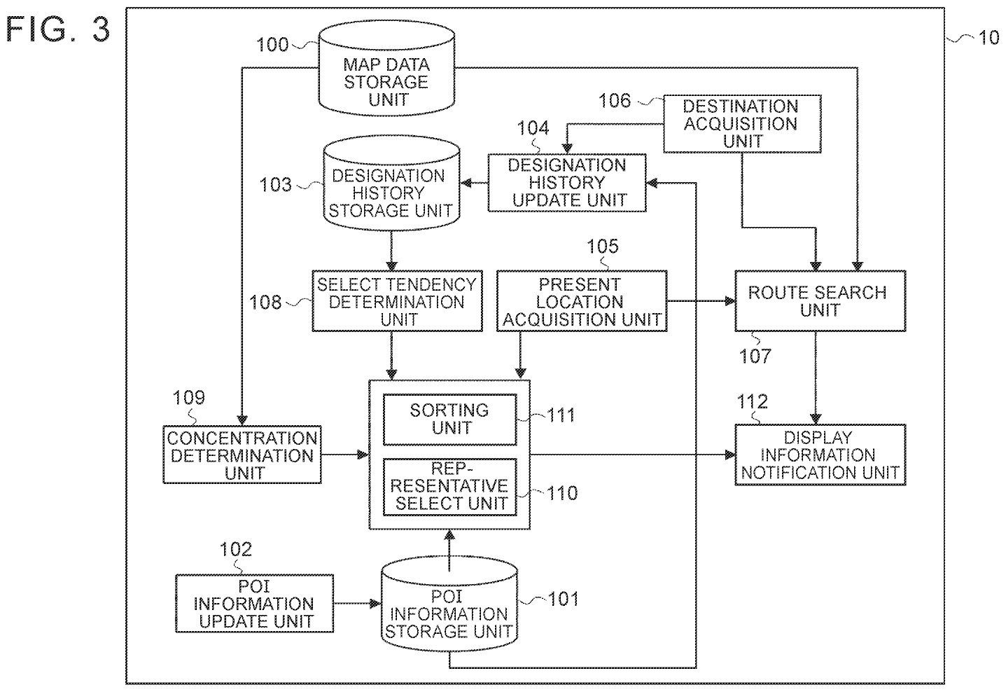

The memory 151 is constituted by a combination of a volatile memory and a non-volatile memory, for example. The memory 151 is used to store software (computer program) that includes one or more instructions executed by the processor 152, data used for various processes performed by the information processing device 10, etc. A map data storage unit 100, a Point-of-Interest (POI) information storage unit 101, and a designation history storage unit 103 illustrated in FIG. 3 to be described later are implemented by the memory 151, for example. However, such units may be implemented by a different storage device.

The processor 152 reads software (computer program) from the memory 151 and executes the software (computer program) to perform processes of constituent elements illustrated in FIG. 3 to be described later. Specifically, the processor 152 performs processes of a POI information update unit 102, a designation history update unit 104, a present location acquisition unit 105, a destination acquisition unit 106, a route search unit 107, a select tendency determination unit 108, a concentration determination unit 109, a representative select unit 110, a sorting unit 111, and a display information notification unit 112.

The processor 152 may be, for example, a microprocessor, a microprocessing unit (MPU), or a central processing unit (CPU), and the like. The processor 152 may include a plurality of processors. In this manner, the information processing device 10 is a device that functions as a computer.

FIG. 3 is a block diagram illustrating an example of the functional configuration of the information processing device 10. As illustrated in FIG. 3, the information processing device 10 has the map data storage unit 100, the POI information storage unit 101, the POI information update unit 102, the designation history storage unit 103, the designation history update unit 104, the present location acquisition unit 105, the destination acquisition unit 106, the route search unit 107, the select tendency determination unit 108, the concentration determination unit 109, the representative select unit 110, the sorting unit 111, and the display information notification unit 112.

The map data storage unit 100 stores map data including road map data, data on the positions of facilities such as parking lots, etc.

The POI information storage unit 101 stores a database of detailed information on the facilities. In the present embodiment, the POI information storage unit 101 includes, the name, the address, the maximum number of vehicles that can be parked, the present status of vacancy of parking spaces, the parking fee, an index value of the evaluation of the facility, an index value of the ease of parking of a vehicle, etc., for example, as information on the parking lots. The present status of vacancy of parking spaces may be information that indicates whether the parking spaces are fully occupied or there is any vacant space, or may be information that indicates the number of vacant spaces. The index value of the evaluation of the facility is an index value that numerically indicating the rating of the facility by various users. The index value of the ease of parking of a vehicle is an index value that indicates whether it is easy to move a vehicle to a parking position. The index value may be a value calculated from values collected from various vehicles about correction of the direction of the vehicle, such as the number of turns and the amount of rotation of the steering wheel made in the parking lot, or may be an index value that numerically indicating the rating of the ease of parking of a vehicle by various users, for example.

A part or all of the information stored in the POI information storage unit 101 is updated, as appropriate, by the POI information update unit 102. The POI information update unit 102 updates the information stored in the POI information storage unit 101. The POI information update unit 102 acquires information managed by an operating company of the facility (parking lot) via a network, and updates the information stored in the POI information storage unit 101 using the acquired information, for example. For example, the present status of vacancy of parking spaces is updated to the latest state any time through an update process by the POI information update unit 102.

The designation history storage unit 103 stores a designation history which is a history of a user's designations of facilities that belong to a predetermined category. In the present embodiment, the designation history storage unit 103 stores a history of designations of facilities as the destination for each user. The designation history storage unit 103 also stores information about the facilities at the designated time. That is, the designation history storage unit 103 stores the information stored in the POI information storage unit 101 at the designated time. For example, the designation history storage unit 103 stores the present status of vacancy of parking spaces at the designated time. The designation history storage unit 103 preferably stores information fluctuated temporally (such as the status of vacancy), among the information stored in the POI information storage unit 101, together with information that identifies the designated facility (destination). However, the designation history storage unit 103 may also store static information (such as the maximum number of vehicles that can be parked). The designation history storage unit 103 also stores the distance from the present location of the user at the designated time to the facility.

The designation history stored in the designation history storage unit 103 is updated by the designation history update unit 104. When the destination acquisition unit 106 acquires information that indicates the destination designated by the user, the designation history update unit 104 stores the destination in the designation history storage unit 103 as a history of the user's designations. In this event, as described above, the designation history update unit 104 may also store information about the facility at the designated time in the designation history storage unit 103. For example, the designation history update unit 104 may reference the POI information storage unit 101, or reference information on the present location acquired by the present location acquisition unit 105, to store information about the facility (e.g. the status of vacancy and the distance) at the designated time in the designation history storage unit 103. Consequently, data that indicate what facility under what condition the user preferentially selects as the destination are accumulated in the designation history storage unit 103.

The present location acquisition unit 105 acquires the present location of a user, that is, the present location of the terminal device 20 (vehicle 90). Specifically, the present location acquisition unit 105 acquires, via the network interface 150, information on the present location transmitted from the terminal device 20. The information on the present location acquired by the present location acquisition unit 105 is used for a process by the sorting unit 111, a process by the route search unit 107, etc.

The destination acquisition unit 106 acquires a destination designated by the user. Specifically, the destination acquisition unit 106 acquires, via the network interface 150, information on the destination transmitted from the terminal device 20 each time the destination is designated on the terminal device 20. The information on the destination acquired by the destination acquisition unit 106 is used for a process by the designation history update unit 104, a process by the route search unit 107, etc.

The route search unit 107 searches for a route from the present location to the destination using the present location of the user (terminal device 20) acquired by the present location acquisition unit 105, the destination acquired by the destination acquisition unit 106, and the map data stored in the map data storage unit 100. The route search unit 107 searches for a route using any known route search algorithm. The route search unit 107 outputs a found route to the display information notification unit 112.

The select tendency determination unit 108 determines the tendency of the user to select a facility based on the history of the user's designations of facilities that belong to a predetermined category. Specifically, the select tendency determination unit 108 determines, based on the history of the user's designations of facilities associated with a plurality of types of information (e.g. various detailed information on the facilities described above), the select tendency of the user that depends on at least one of the types of information. In the present embodiment, specifically, the select tendency determination unit 108 determines, for each user, the tendency of the user to select a parking lot based on the history of the user's designations of parking lots as the destination. In this event, the select tendency determination unit 108 references information about the parking lot designated as the destination, and analyzes what information about the parking lots on which the user places an importance. The information about the parking lots used for the analysis is not limited to the information stored in association with the destination in the designation history storage unit 103 (information that may be fluctuated temporally at the time when the destination is designated), and may include information that is not fluctuated temporally and that is stored in the POI information storage unit 101.

For example, when the user designates only parking lots that are close to the present location of the user, the select tendency determination unit 108 determines that the user tends to select a parking lot that is close to the present location of the user. When the user designates only parking lots with a low parking fee, meanwhile, the select tendency determination unit 108 determines that the user tends to select a parking lot with a low parking fee, for example. When the user designates parking lots having a value of specific information of the facility (e.g. the number of vehicles that can be parked, the number of vacant spaces, the distance, the fee, an index value of evaluation, an index value of the ease of parking of a vehicle, etc.) that meets a predetermined condition (e.g. a predetermined threshold or less or a predetermined threshold or more), at a frequency that is a predetermined threshold or more, the select tendency determination unit 108 determines that the selection by the user depends on the specific information, for example. This determination method is merely exemplary, and the select tendency determination unit 108 may determine the select tendency of the user by performing a desired statistical analysis.

The concentration determination unit 109 determines whether the positions of a plurality of facilities that belongs to a predetermined category is concentrated on a map. In the present embodiment, when a map at a predetermined scale is displayed as an image of a predetermined size, the concentration determination unit 109 determines whether the positions of parking lots are concentrated on the image, for example. Specifically, when POI icons of a predetermined size for parking lots are disposed on the image at positions at which the parking lots are present, the concentration determination unit 109 determines whether the POI icons overlap each other, for example. When the POI icons overlap each other, the concentration determination unit 109 determines that the parking lots corresponding to the overlapping POI icons are present in a concentrated manner.

The representative select unit 110 selects, when it is determined that the positions of a plurality of facilities that belongs to a predetermined category is concentrated on a map, a POI icon to be displayed as the representative on a map image to be displayed, from among the POI icons for the facilities. In other words, the representative select unit 110 selects a representative of the facilities that are present in a concentrated manner, and determines the POI icon corresponding to the facility as a POI icon to be displayed as the representative. The representative select unit 110 selects a representative in accordance with the select tendency determined by the select tendency determination unit 108. For example, when the select tendency determination unit 108 determines that a certain user tends to select a parking lot with a low parking fee, the representative select unit 110 selects the POI icon for a parking lot with the lowest fee, among the parking lots that are present in a concentrated manner, as the POI icon to be displayed as the representative on the map to be presented to the user. In the present embodiment, the representative select unit 110 selects a POI icon to be displayed as the representative using the result of sorting of the facilities by the sorting unit 111. Specifically, the sorting unit 111 sorts the facilities that are present in a concentrated manner in accordance with the select tendency, and the representative select unit 110 selects the POI icon for a facility sorted in the highest rank as a POI icon to be displayed as the representative. When a POI icon to be displayed as the representative is determined, the representative select unit 110 outputs, to the display information notification unit 112, information that indicates the POI icon for what facility is to be displayed as the representative.

A plurality of types of POI icons is prepared for facilities that belong to a predetermined category. That is, in the present embodiment, a plurality of types of POI icons is prepared for parking lots. Different POI icons may be used for each parking lot, or different POI icons may be used for each company that operates parking lots, for example. Thus, the POI icon to be displayed as the representative is varied in accordance with what facility is selected as the representative.

The sorting unit 111 sorts a plurality of facilities that belong to a predetermined category in accordance with the select tendency determined by the select tendency determination unit 108, and determines the order in which information on the facilities is displayed in a list. Specifically, the sorting unit 111 references the detailed information stored in the POI information storage unit 101 on the facilities that are determined to be present in a concentrated manner, and sorts the facilities. When the present location of the terminal device 20 is required to sort the facilities in accordance with the distance, the sorting unit 111 calculates the respective distances to the facilities using the present location acquired by the present location acquisition unit 105, and sorts the facilities.

When it is determined that a certain user tends to select a parking lot with a low fee, for example, the select tendency determination unit 108 sorts the parking lots that are present in a concentrated manner in the ascending order of the parking fee. As described above, the sorting result is used by the representative select unit 110 to select a POI icon to be displayed as the representative. The sorting result is also used as the list order when a list of the detailed information on the concentrated parking lots is displayed for the user. In this manner, a list sorted in accordance with the select tendency of the user can be displayed. Therefore, information on the facilities can be provided in the order of facilities that the user prefers.

The display information notification unit 112 notifies a display control unit 204 of the terminal device 20 of information about display via a display information acquisition unit 203 of the terminal device 20. The display information notification unit 112 notifies the display control unit 204 of the POI icon to be displayed as the representative, among the POI icons for facilities that are present in a concentrated manner, for example. Consequently, the display control unit 204 can display the POI icon for a facility that the user prefers as the representative on the map. When the terminal device 20 does not retain map data, the display information notification unit 112 may transmit map data to the terminal device 20. The display information notification unit 112 also notifies the sorting result which is sorted by the sorting unit 111. Consequently, the display control unit 204 can display information on the facilities in the order of facilities that the user prefers. When the terminal device 20 does not retain detailed information on the facilities, the display information notification unit 112 may transmit detailed information on the facilities to the terminal device 20. When the route search unit 107 has found a route, the display information notification unit 112 may notify the display control unit 204 of the route. Consequently, the display control unit 204 can display the route to the destination on the map.

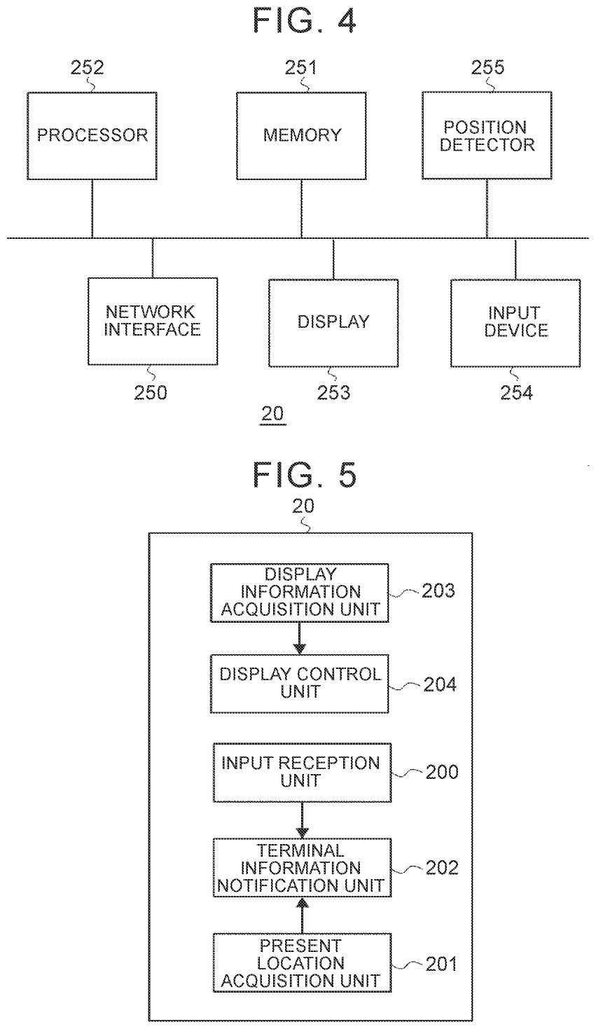

Next, the terminal device 20 will be specifically described. FIG. 4 is a block diagram illustrating an example of the hardware configuration of the terminal device 20. As illustrated in FIG. 4, the terminal device 20 includes a network interface 250, a memory 251, a processor 252, a display 253, an input device 254, and a position detector 255.

The network interface 250 is used to communicate with any different device. For example, the network interface 250 may be an interface connected to a controller area network (CAN) of the vehicle 90. In the present embodiment, the network interface 250 is used to communicate with the information processing device 10.

The memory 251 is constituted by a combination of a volatile memory and a non-volatile memory, for example. The memory 251 is used to store software (computer program) that includes one or more instructions executed by the processor 252, data used for various processes performed by the terminal device 20, etc. For example, the memory 251 may store map data, or may store detailed information on the facilities. Such stored information may be provided from the information processing device 10.

The processor 252 reads software (computer program) from the memory 251 and executes the software (computer program) to perform processes of constituent elements illustrated in FIG. 5 to be described later. Specifically, the processor 252 performs processes of an input reception unit 200, a present location acquisition unit 201, a terminal information notification unit 202, the display information acquisition unit 203, and the display control unit 204.

The processor 252 may be a microprocessor, an MPU, or a CPU, for example. The processor 152 may include a plurality of processors. In this manner, the terminal device 20 is a device that functions as a computer.

The program described above executed by the information processing device 10 or the terminal device 20 can be stored using a non-transitory computer readable medium of various types and supplied to a computer. The non-transitory computer readable medium includes a tangible storage medium of various types. Examples of the non-transitory computer readable medium include a magnetic storage medium (e.g. a flexible disk, a magnetic tape, and a hard disk drive), a magneto-optical storage medium (e.g. a magneto-optical disk), a compact disc read only memory (CD-ROM), a compact disc recordable (CD-R), a compact disc rewritable (CD-R/W), and a semiconductor memory (e.g. a mask ROM, a programmable ROM (PROM), an erasable PROM (EPROM), a flash ROM, and a random access memory (RAM)). In addition, the program may be supplied to a computer through a transitory computer readable medium of various types. Examples of the transitory computer readable medium include an electric signal, an optical signal, and an electromagnetic wave. The transitory computer readable medium can supply the program to a computer via a wired communication path such as an electric wire or optical fibers or a wireless communication path.

The display 253 is used to display a map etc. Examples of the display 253 include a flat panel display such as a liquid crystal display, a plasma display, and an organic electro-luminescence (EL) display. The input device 254 is a device that receives an input from the user. For example, the input device 254 may be integrated with the display 253 to be constituted as a touch panel.

The position detector 255 detects the present position of the terminal device 20 (vehicle 90). The position detector 255 may be a global navigation satellite system (GNSS) receiver or may be a gyroscope etc., for example.

FIG. 5 is a block diagram illustrating an example of the functional configuration of the terminal device 20. As illustrated in FIG. 5, the terminal device 20 has the input reception unit 200, the present location acquisition unit 201, the terminal information notification unit 202, the display information acquisition unit 203, and the display control unit 204.

The input reception unit 200 receives an input from the user via the input device 254. For example, the input reception unit 200 receives an input to designate a destination from the user. The input reception unit 200 also receives an input (e.g. an input to select by tapping) to select a POI icon, an item, etc. displayed on the display 253, for example.

The present location acquisition unit 201 acquires information that indicates the present location of the terminal device 20 (vehicle 90). Specifically, the present location acquisition unit 201 acquires position information detected by the position detector 255.

The terminal information notification unit 202 notifies the information processing device 10 of the information acquired by the terminal device 20. For example, when a destination is designated in an input from the user, the terminal information notification unit 202 notifies the information processing device 10 of the present location and the destination designated in the input. Since the select tendency is determined for each user, the terminal information notification unit 202 notifies the information processing device 10 of information such as the destination together with information for identifying the user. The terminal information notification unit 202 may notify the information processing device 10 of the present location any time. The terminal information notification unit 202 is also referred to as a destination notification unit. As described above, the select tendency determination unit 108 of the information processing device 10 determines the tendency of the user to select a facility based on a history for facilities that belong to a predetermined category (parking lots in the present embodiment), among a history of destinations notified from the terminal device 20. In this manner, it is possible to easily acquire information for determining the select tendency. Since the tendency to select a destination can be obtained, display that reflects the preference of the user for the destination can be made by determining a POI icon as the representative in accordance with the select tendency.

The display information acquisition unit 203 acquires information about display from the information processing device 10. Specifically, the display information acquisition unit 203 acquires, via the network interface 250, information output from the display information notification unit 112 of the information processing device 10. The display information acquisition unit 203 acquires, as the information about display, information that indicates which of the POI icons for the facilities that are present in a concentrated manner is the POI icon to be displayed as the representative, the result of sorting of the facilities that are present in a concentrated manner, the route to the destination, etc., for example. The information about display acquired by the display information acquisition unit 203 is used for a process by the display control unit 204.

The display control unit 204 controls display of a map on the display 253. In particular, the display control unit 204 performs control so as to display, on the display 253, the POI icon for the facility selected by the representative select unit 110 described above on the map as the representative of the POI icons for the concentrated facilities. That is, the display control unit 204 performs control so as to display, on the map, only the POI icon for the facility selected by the representative select unit 110 in accordance with the select tendency, among the POI icons for the concentrated facilities. The display control unit 204 has a function to control display of the POI icon based on the information acquired by the display information acquisition unit 203.

The display control unit 204 performs control so as to display the POI icon for the facility selected in accordance with the select tendency, that is, the representative POI icon, at the position of the facility on the map. In this manner, the POI icon for the facility that the user prefers is displayed at the position of the facility. Therefore, the position of the facility that the user prefers can be displayed in an easily seeable manner. The display control unit 204 may not necessarily display the representative POI icon at the position at which the facility corresponding to the POI icon is present. For example, the display control unit 204 may display the representative POI icon at the central position of all the positions at which the facilities that are present in a concentrated manner are present etc.

When a destination is designated, the display control unit 204 may display the representative POI icon on the map together with an acquired route. The display control unit 204 may display a list of detailed information on the facilities that are present in a concentrated manner when the representative POI icon displayed on the map is tapped, that is, when an input operation is performed to select the representative POI icon displayed on the map. At this time, the display control unit 204 displays a list sorted in accordance with the determined select tendency.

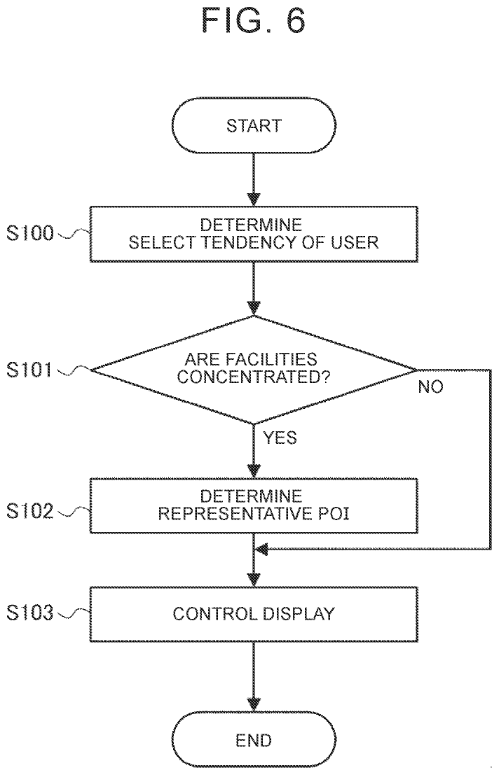

Next, the flow of a POI icon display process performed by the display system 1 will be described. FIG. 6 is a flowchart illustrating an example of the POI icon display process performed by the display system 1. The flow of the process will be described below with reference to FIG. 6.

In step S100, the select tendency determination unit 108 determines the tendency of the user to select a facility based on the history of the user's designations of facilities that belong to a predetermined category. Consequently, the select tendency of the user who sees a map displayed on the terminal device 20 is determined.

Next, in step S101, the concentration determination unit 109 determines whether the positions of a plurality of facilities that belong to a predetermined category are concentrated on the map to be displayed. When the facilities are present in a concentrated manner, the process proceeds to step S102. Otherwise, the process proceeds to step S103.

In step S102, the representative select unit 110 selects a POI icon to be displayed as the representative, among the POI icons for the facilities that are present in a concentrated manner, in accordance with the select tendency determined in step S100. In the present embodiment, the representative select unit 110 selects a representative using the result of sorting performed by the sorting unit 111 prior to the selection by the representative select unit 110. A sorting process may not necessarily be performed in order to select a POI icon to be displayed as the representative. In this case, the sorting process is not performed.

In step S103, the display control unit 204 controls display of the POI icon on the display 253. When the facilities are not present in a concentrated manner, the display control unit 204 performs control so as to display the respective POI icons for such facilities on the map on the display 253. When the facilities are present in a concentrated manner, on the contrary, the display control unit 204 performs control so as to display the POI icon selected in step S102 on the map on the display 253 as the representative of the POI icons for the facilities that are present in a concentrated manner. Consequently, the POI icon for the facility selected in accordance with the select tendency of the user who views the map is displayed on the map as a representative POI icon.

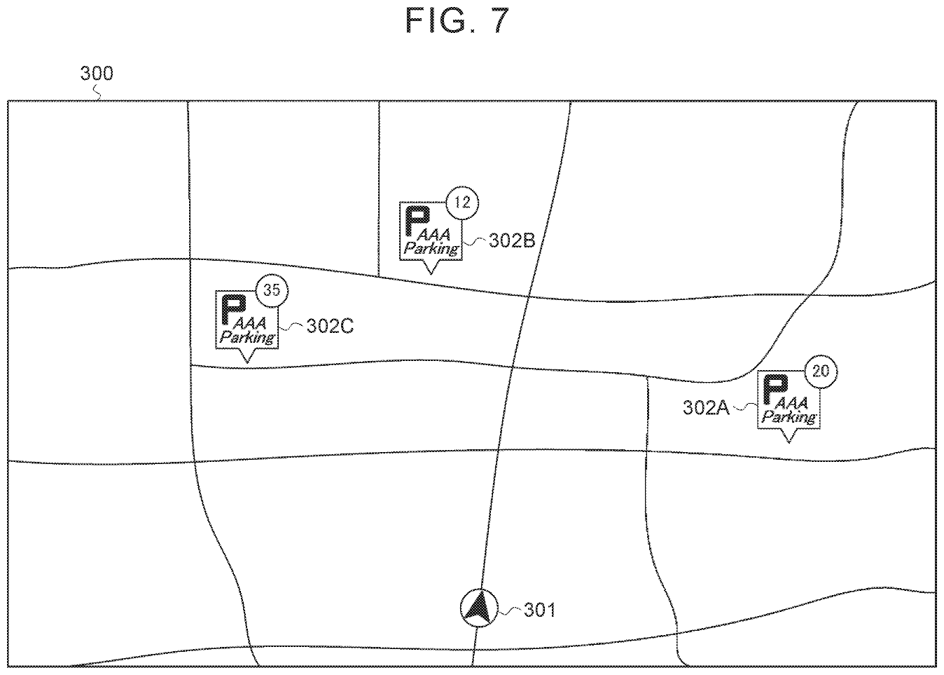

FIG. 7 illustrates an example of a map image 300 displayed by the display system 1. In FIG. 7 and FIGS. 8 and 9 to be described later, roads are indicated by continuous lines in the map image 300. The present location of the vehicle 90 (terminal device 20) is indicated by a present location icon 301.

In the example illustrated in FIG. 7, parking lots are concentrated at three locations on the map. Consequently, representative POI icons 302A, 302B, and 302C for the parking lots are displayed, rather than displaying the respective POI icons for the parking lots that are present in a concentrated manner, at the locations at which the parking lots are concentrated. The POI icons 302A, 302B, and 302C are each a POI icon corresponding to the parking lot that the user prefers, among the plurality of types of POI icons for parking lots.

As illustrated in FIG. 7, the number of POI icons aggregated may be displayed together with the POI icon displayed as the representative. In the example illustrated in FIG. 7, the number of facilities aggregated is indicated at the upper right of the POI icons 302A, 302B, and 302C. That is, the display control unit 204 may perform control so as to display the number of facilities determined to be concentrated together with the POI icons for the facilities selected in accordance with the select tendency. The number of facilities aggregated is notified from the display information notification unit 112 to the display control unit 204, for example. In this manner, the total number of concentrated facilities is displayed. Therefore, convenience to the user can be further improved. Since numerals are displayed together with the POI icons, the user can easily understand that one POI icon is displayed by aggregating a plurality of POI icons. By displaying the POI icons displayed as the representative with predetermined decoration added thereto, the user may be able to easily understand that the POI icon is an aggregation of a plurality of POI icons.

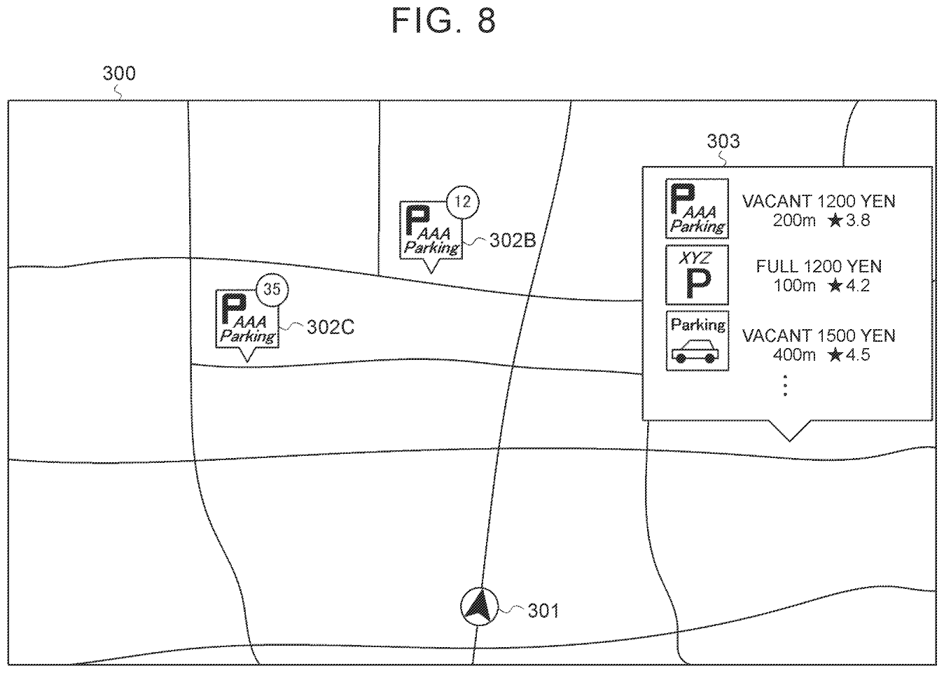

When any of the POI icons displayed as the representative is selected, the display control unit 204 displays a list of detailed information on the aggregated facilities, that is, the facilities that are present in a concentrated manner. For example, when the POI icon 302A is tapped, the display control unit 204 displays a list 303 as illustrated in FIG. 8. In the list 303, detailed information on the parking lots is displayed as sorted in accordance with the determined select tendency. The list 303 indicated by way of example indicates, for each parking lot, the POI icon, the present status of vacancy of parking spaces, the parking fee, the distance from the present location of the vehicle 90 to the parking lot, and the index value of the ease of parking of a vehicle.

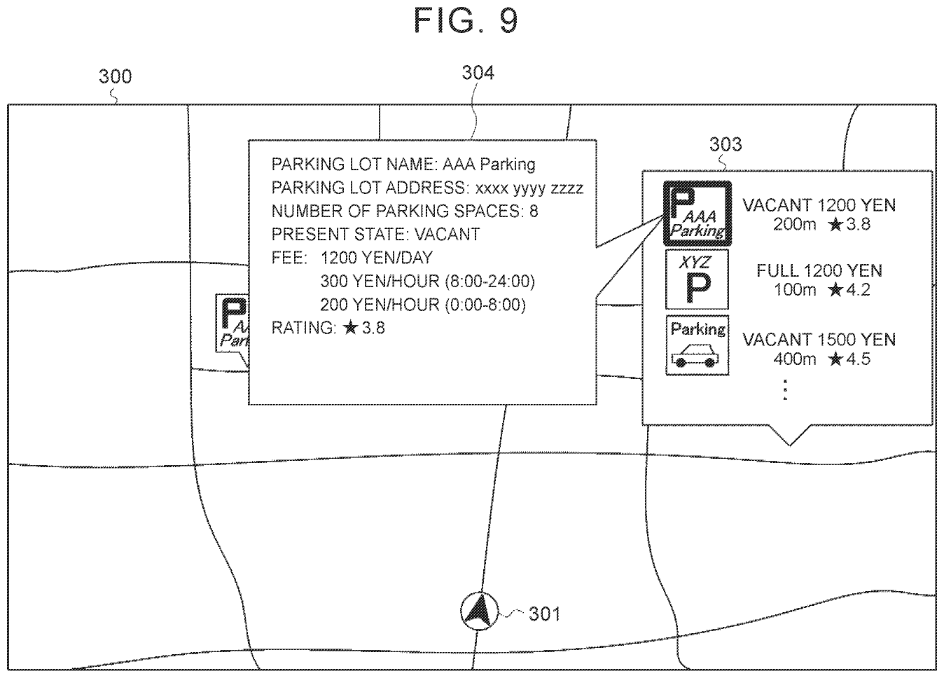

As illustrated in FIG. 9, the display control unit 204 may display further detailed information 304 on a facility given in the list 303.

The embodiment has been described above. In the embodiment described above, the tendency of the user to select a facility is determined based on the history of the user's designations of facilities. When the positions of a plurality of facilities are concentrated on a map, a POI icon to be displayed as the representative is selected in accordance with the select tendency, from among the POI icons for the facilities. With such processing, when the positions of the facilities are concentrated on the map, the POI icon for a facility that matches the select tendency of the user can be displayed on the map as a representative icon. Therefore, an icon for a facility that the user prefers can be displayed as the representative icon. Thus, viewability can be improved while improving convenience to the user in displaying a map with a POI icon.

In particular, a history of facilities designated as the destination can be used as the designation history described above. In this case, the select tendency of the user is determined based on whether the facility is designated as the destination. Therefore, display that reflects the preference of the user for the destination can be made. The designation history that is used to determine the select tendency is not limited to a history of designations of destinations, and may be a history of designations of facilities for any purpose desired by the user.

As described above, the select tendency determination unit 108 determines, based on a history of the user's designations of facilities associated with a plurality of types of information, the select tendency which depends on any of such information. Therefore, a representative icon is determined in accordance with the information on which the user places an importance. Hence, display that reflects the preference of the user for the information on which the user places an importance can be made. The distance from the present location to the facility, the evaluation of the facility, the parking fee, the status of vacancy of parking spaces, the ease of parking of a vehicle, etc. can be used as such information. Therefore, display that reflects the preference of the user for such information can be made. Alternatively, the distance from a different destination that has already been set to the facility may be used in place of the distance from the present location to the facility. In this case, when an additional destination (e.g. a parking lot) is designated with a destination (e.g. a facility other than parking lots) already set, the designation history storage unit 103 may store the distance from the destination that has already been set to the destination that has been set additionally as a history of designations of destinations designated additionally, for example. Consequently, the select tendency for a parking lot to be used in order to visit a facility that has already been set as the destination can be determined based on the distance therebetween, for example.

The present disclosure is not limited to the embodiment described above, and can be modified, as appropriate, without departing from the scope and spirit of the present disclosure. In the embodiment described above, for example, parking lots are taken as examples of the facilities. However, the processes described above may also be performed regarding display of POI icons for other facilities. For example, the processes described above may be performed regarding display of POI icons for stations for replenishing vehicles with energy such as gasoline stations and charging stations, or the processes described above may be performed regarding display of POI icons for convenience stores.

In the display system 1 described above, in addition, the processes for display are performed by the information processing device 10 and the terminal device 20. However, at least a part of the processes described as being performed by the information processing device 10 may be performed by the terminal device 20, and at least a part of the processes described as being performed by the terminal device 20 may be performed by the information processing device 10. In addition, at least a part of the processes described as being performed by the information processing device 10 or the terminal device 20 may be performed by a different device.

What is claimed is:

1. An information processing device comprising a processor configured to:
determine a select tendency of a user in selecting a facility based on a history of the user's designations of the facility that belongs to a predetermined category;
determine whether positions of a plurality of facilities are concentrated on a map; and
select, when the positions of the facilities are concentrated on the map, a Point-of-Interest icon to be displayed as a representative in accordance with the select tendency, from among Point-of-Interest icons for the facilities.

2. The information processing device according to claim 1, wherein the processor is configured to:
sort the facilities in accordance with the select tendency; and
determine an order in which information on the facilities is displayed in a list.

3. The information processing device according to claim 1, wherein the history of the user's designations is a history that the user designated the facilities as a destination.

4. The information processing device according to claim 1, wherein the processor is configured to determine the select tendency of the user based on the history of the user's designations of the facilities associated with a plurality of types of information, the select tendency depending on at least one of the types of information.

5. The information processing device according to claim 4, wherein the types of information include a distance from a present location of the user to the facility or a distance from a destination that is different from the facility to the facility.

6. The information processing device according to claim 4, wherein the types of information include an index value of evaluation of the facility.

7. The information processing device according to claim 4, wherein:
the facility is a parking lot; and
the types of information include a parking fee of the parking lot.

8. The information processing device according to claim 4, wherein:
the facility is a parking lot; and
the types of information include a status of vacancy of parking spaces in the parking lot.

9. The information processing device according to claim 4, wherein:
the facility is a parking lot; and
the types of information include an index value of ease of parking of a vehicle in the parking lot.

10. A display system, comprising:
an information processing device configured to
determine a select tendency of a user in selecting a facility, based on a history of the user's designations of the facility that belongs to a predetermined category,
determine whether positions of a plurality of facilities are concentrated on a map, and
select, when the positions of the facilities are concentrated on the map, a Point-of-Interest icon to be displayed as a representative, from among Point-of-Interest icons for the facilities, in accordance with the select tendency; and
a terminal device, that includes a display, configured to control display on the display so as to display, on the display, the Point-of-Interest icon for the facility selected by the information processing device on the map as a representative of the Point-of-Interest icons for the facilities.

11. The display system according to claim 10, wherein the terminal device is configured to control display on the display so as to display the number of facilities determined as concentrated together with the Point-of-Interest icon for the facility selected in accordance with the select tendency.

12. The display system according to claim 10, wherein the terminal device is configured to control display on the display so as to display the Point-of-Interest icon for the facility selected in accordance with the select tendency at a position of the facility on the map.

13. The display system according to claim 10, wherein:
the terminal device is configured to receive an input to designate the facility that belongs to the predetermined category as a destination from the user, and notify the information processing device of the destination designated by the input; and
the information processing device is configured to determine the select tendency of the user in selecting the facility based on the history of the user's designations of the facility that belongs to the predetermined category, the facility being designated as the destination, the history of the user's designations being communicated from the terminal device.

14. A display control method, comprising:
determining a select tendency of a user in selecting a facility based on a history of the user's designations of the facility that belongs to a predetermined category;
determining whether positions of a plurality of facilities are concentrated on a map; and
selecting, when the positions of the facilities are concentrated on the map, a Point-of-Interest icon to be displayed as a representative in accordance with the select tendency, from among Point-of-Interest icons for the facilities.

15. A non-transitory readable medium storing instructions that are executable by one or more processors and that cause the one or more processors to perform functions, comprising:
determining a select tendency of a user in selecting a facility, based on a history of the user's designations of the facility that belongs to a predetermined category;
determining whether positions of a plurality of facilities are concentrated on a map; and
selecting, when the positions of the facilities are concentrated on the map, a Point-of-Interest icon to be displayed as a representative in accordance with the select tendency, from among Point-of-Interest icons for the facilities.
